(19) United States
(12) Patent Application Publication
(10) Pub. No.: US 2025/0020225 A1
(43) Pub. Date: Jan. 16, 2025

(54) CONTROL VALVE

(71) Applicant: YAMADA MANUFACTURING CO., LTD., Kiryu-shi, Gunma (JP)

(72) Inventor: Akifumi Ozeki, Kiryu-shi (JP)

(21) Appl. No.: 18/713,517

(22) PCT Filed: Dec. 5, 2022
(86) PCT No.: PCT/JP2022/044700

§ 371 Date: May 24, 2024

(30) Foreign Application Priority Data
Dec. 13, 2021 (JP) 2021-201629

(51) Int. Cl. F16K 11/083

(52) U.S. Cl. CPC F16K 11/0833

(57) ABSTRACT

A control valve includes a casing and a rotor. The casing has an inlet and an outlet. The rotor has a peripheral wall in which communication ports are formed. The peripheral wall of the rotor has a gradually decreasing diameter surface of which an outer diameter gradually decreases from one end side to the other end side in an axial direction and in which the communication port is formed. The rotor accommodating portion of the casing has a rotor guide surface in which an amount of protrusion inward in the radial direction gradually increases from one end side to the other end side in the axial direction, and of which an inner end surface in the radial direction is slidably in contact with the gradually decreasing diameter surface of the peripheral wall. An outlet is disposed in a part of the rotor guide surface so as to face the peripheral wall of the rotor.

### TECHNICAL FIELD

The present invention relates to a control valve.

Priority is claimed on Japanese Patent Application No. 2021-201629, filed Dec. 13, 2021, the content of which is incorporated herein by reference.

### BACKGROUND ART

Vehicles are equipped with a cooling system that cools a heat generating portion using a cooling liquid that circulates between a heat generating portion (for example, an engine, a motor, or the like) and a heat radiating part (for example, a radiator, a heater core, or the like). In this type of cooling system, a control valve is provided on a flow path that connects a heat generating portion and a heat radiating part to control a flow of the cooling liquid.

As the above-described control valve, for example, Patent Document 1 below discloses a configuration including a casing having an outlet of a cooling liquid and a tubular rotor with a bottom that is rotatably provided within the casing. A communication port which allows communication between an inner space of the rotor and an outlet according to rotation of the rotor is formed in a tubular portion of the rotor.

According to such a configuration, communication and disconnection between the outlet and the communication port can be switched between by rotating the rotor. The cooling liquid that is introduced into the control valve flows into the inner space of the rotor and then flows out of the control valve through the outlet that communicates with the communication port. Thus, the cooling liquid that is introduced into the control valve is distributed to a desired heat radiating part in accordance with the rotation of the rotor.

Further, in this control valve, a seal cylinder of which an end surface is slidably in contact with an outer peripheral surface of the rotor is mounted in the outlet so as to be movable forward and backward. The seal cylinder is biased in a direction of the outer peripheral surface of the rotor by a biasing member such as a coil spring.

In the control valve, with the above-described configuration, even when the tubular portion of the rotor expands and contracts due to heat, communication and disconnection between the outlet and the communication port can be stably performed. That is, when the tubular portion of the rotor expands and contracts due to heat, the seal cylinder is displaced forward and backward according to a change in an outer diameter of the tubular portion, and accordingly, a state of contact between an outer peripheral surface of the tubular portion of the rotor and the seal cylinder is maintained.

### CITATION LIST

### Patent Document

Patent Document 1: Japanese Unexamined Patent Application, First Publication No. 2020-197305

### SUMMARY OF INVENTION

### Technical Problem

In the conventional control valve described above, the rotor is rotatably supported by a casing via a dedicated bearing provided between the rotor and the casing. Further, the seal cylinder and the biasing member described above are assembled at a position outside the rotor in a radial direction within the casing. Thus, the conventional control valve described above has a large number of parts and a complicated structure, and there is still room for improvement in reducing a size of the entire device.

An aspect of the present invention has been made in consideration of such circumstances, and an object thereof is to provide a control valve capable of reducing the number of parts, simplifying a structure, and reducing a size of an entire device.

### Solution to Problem

In order to solve the above problems, the present invention employs the following aspects.

(1) A control valve according to one aspect of the present invention includes a casing having an inlet through which a fluid is introduced from outside and an outlet through which the fluid flows out to the outside, and a rotor having a peripheral wall in which a communication port passing therethrough in a radial direction is formed, rotatably accommodated inside the casing, and configured to switch between a communication state in which the inlet and the outlet communicate with each other through the communication port and a blocking state in which communication between the inlet and the outlet is blocked in a region of the peripheral wall in which the communication port is not provided, according to a rotational position, wherein the peripheral wall of the rotor has a gradually decreasing diameter surface of which an outer diameter gradually decreases from one end side to the other end side in an axial direction along a rotational axis of the rotor and in which the communication port is formed, a rotor accommodating portion of the casing that accommodates the rotor has a rotor guide surface in which an amount of protrusion inward in the radial direction gradually increases from the one end side to the other end side in the axial direction and an inner end surface in the radial direction is slidably in contact with the gradually decreasing diameter surface of the peripheral wall, and the outlet is disposed in a part of the rotor guide surface to face the gradually decreasing diameter surface of the rotor.

According to the above aspect, the rotor accommodated in the casing is slidably supported by the rotor guide surface on the casing side in the gradually decreasing diameter surface. Since the outlet is disposed in the rotor guide surface so as to face the gradually decreasing diameter surface of the rotor, the outlet is opened and closed by the gradually decreasing diameter surface of the rotor according to a rotational position of the rotor (opened and closed by a region in which the communication port is present and a region in which the communication port is not present in the gradually decreasing diameter surface).

In addition, since both the gradually decreasing diameter surface and the rotor guide surface are inclined or curved radially inward from the same end side to the same other end side in the axial direction, when an outer diameter of the peripheral wall of the rotor expands and contracts due to heat, the rotor is displaced in the axial direction on the rotor guide surface in accordance with an increase or decrease in the outer diameter of the peripheral wall. Therefore, the gradually decreasing diameter surface of the rotor is stably and slidably supported on the rotor guide surface, regardless of the expansion and contraction changes of the peripheral wall due to heat. Therefore, it becomes possible to omit a dedicated bearing for rotatably supporting the rotor on the casing, and it becomes possible to omit a seal cylinder for allowing communication between the outlet and the communication port in the peripheral wall of the rotor and a biasing member for biasing the seal cylinder in a direction of the peripheral wall of the rotor.

(2) In the aspect (1), the gradually decreasing diameter surface may be formed by a tapered surface of which an outer diameter gradually decreases at a constant rate from the one end side to the other end side in the axial direction, and the rotor guide surface may be formed by a tapered surface of which an amount of protrusion inward in the radial direction gradually increases from the one end side to the other end side in the axial direction at the same constant rate as the gradually decreasing diameter surface.

In this case, since the gradually decreasing diameter surface and the rotor guide surface are formed by tapered surfaces inclined at the same angle, even when the peripheral wall of the rotor expands and contracts due to heat and the rotor is displaced in the axial direction, it is possible to bring the gradually decreasing diameter surface into stable contact with the rotor guide surface over a wide area.

(3) In the aspect (1) or (2), in the rotor, an opening portion may be provided on the one end side of the peripheral wall in the axial direction, and the other end side in the axial direction may be closed by a bottom wall, and the opening portion may communicate with the inlet.

In this case, when a fluid is introduced into the casing from the inlet, the fluid is introduced into the peripheral wall through the opening portion of the rotor. At this time, the rotor is pressed to the other end side in the axial direction by a pressure of the fluid, and a component force thereof acts as a pressing force that presses the gradually decreasing diameter surface of the rotor against the rotor guide surface on the casing side. As a result, when the gradually decreasing diameter surface of the rotor is pressed against a peripheral edge portion of the outlet of the rotor guide surface and the communication port of the rotor communicates with the outlet, leakage of the fluid from the peripheral edge portion of the outlet is curbed. Further, when the communication port of the rotor does not communicate with the outlet, leakage of the fluid to the communication port is curbed.

(4) In the aspect (3), the inlet may be formed in a tubular wall that extends into the opening portion in the axial direction of the peripheral wall.

In this case, when the fluid is introduced into the peripheral wall of the rotor from the inlet, a flow of the fluid is less likely to directly hit an end portion of the peripheral wall on one end side in the axial direction or a peripheral portion thereof. Therefore, it is possible to curb pressure loss of the fluid introduced into the peripheral wall of the rotor.

(5) In any one of the aspects (1) to (4), a biasing member that urges the rotor to the other end side in the axial direction may be disposed between the casing and the rotor.

In this case, the component force of the biasing member that urges the rotor to the other end side in the axial direction acts as a force that presses the gradually decreasing diameter surface of the rotor against the rotor guide surface on the casing side. As a result, a peripheral edge portion of the outlet of the rotor guide surface is pressed against the gradually decreasing diameter surface of the rotor, and leakage of the fluid at the peripheral edge portion of the outlet is curbed.

(6) In any one of the aspects (1) to (5), the rotor guide surface may be formed in an annular shape in the rotor accommodating portion to surround a peripheral region of the gradually decreasing diameter surface.

In this case, since a peripheral region of the gradually decreasing diameter surface on the rotor side comes into contact with the annular rotor guide surface, the rotor is maintained in a stable posture during rotation of the rotor.

(7) In any one of the aspects (1) to (5), a plurality of boss portions that protrude toward the gradually decreasing diameter surface of the rotor may be provided on an inner peripheral surface of the rotor accommodating portion, and an end surface of each of the boss portions may serve as the rotor guide surface, and the outlet may be disposed in an end surface of at least one of the boss portions.

In this case, since only the end surface of each of the boss portions comes into contact with the gradually decreasing diameter surface on the rotor side as the rotor guide surface, a contact area between the gradually decreasing diameter surface and the rotor guide surface becomes small. Therefore, sliding resistance during the rotation of the rotor is reduced, and the rotation of the rotor becomes smoother.

(8) In the aspect (7), the plurality of boss portions may be provided on the inner peripheral surface of the rotor accommodating portion at equal intervals in a circumferential direction.

In this case, since the plurality of rotor guide surfaces are evenly in contact with the peripheral wall (the gradually decreasing diameter surface) of the rotor in the circumferential direction, the peripheral wall of the rotor is stably supported by the plurality of rotor guide surfaces.

(8) In the aspect (5), the biasing member may be a coil spring, and a spring receiving member having a flat contact surface with the rotor may be disposed at an end portion of the coil spring on the rotor side.

In this case, the biasing member is constituted by a coil spring that is highly durable and has a simple structure. Since a contact surface with the rotor is in contact with the rotor via the flat spring receiving member, the coil spring can prevent an end portion of the coil spring from interfering with the rotation of the rotor when the rotor rotates, and can also prevent the end portion of the coil spring from damaging the end surface of the rotor. As a result, it is possible to obtain smooth rotation of the rotor, and it is also possible to prevent damage to the rotor.

### Advantageous Effects of Invention

In the aspect of the present invention, the gradually decreasing diameter surface of the peripheral wall of the rotor and the rotor guide surface on the casing side are both inclined or curved radially inward from the same end side to the same other end side in the axial direction, and the outlet is disposed in the rotor guide surface on the casing side so as to face the gradually decreasing diameter surface on the rotor side. Therefore, the peripheral wall of the rotor can always be stably and slidably supported by the rotor guide surface on the casing side. Furthermore, since a peripheral edge portion of the rotor guide surface in which the outlet is disposed is slidably in contact with the gradually decreasing diameter surface on the rotor side, it is possible to omit a seal cylinder for allowing communication between the outlet and the communication port in the peripheral wall of the rotor and a biasing member for biasing the seal cylinder toward the peripheral wall of the rotor.

Therefore, when the aspect of the present invention is adopted, the number of parts such as bearings, seal cylinders, and biasing members can be reduced and the structure can be simplified, thereby making it possible to reduce a size of the entire device.

### BRIEF DESCRIPTION OF DRAWINGS

FIG. 1 is a block diagram of a cooling system according to an embodiment.

FIG. 2 is a perspective view of a control valve according to a first embodiment.

FIG. 3 is an exploded perspective view of the control valve according to the first embodiment.

FIG. 4 is a cross-sectional view taken along line IV-IV in FIG. 2.

FIG. 5 is a cross-sectional view of a control valve according to a second embodiment, which corresponds to FIG. 4.

FIG. 6 is a cross-sectional view of a control valve according to a third embodiment, which corresponds to a cross section taken along line VI-VI in FIG. 2.

FIG. 7 is a sectional view of a control valve according to a fourth embodiment, which corresponds to FIG. 4.

### DESCRIPTION OF EMBODIMENTS

Next, embodiments of the present invention will be described on the basis of the drawings. In each of the embodiments described below, corresponding components may be designated by the same reference numerals and description thereof may be omitted.

In the following description, for example, expressions indicating a relative or absolute arrangement such as “parallel,” “orthogonal,” “centered,” and “coaxial” do not only refer strictly to such arrangements, and also indicate states of being relatively displaced by an angle or distance that allows the same tolerances and functions to be obtained.

### [Cooling System 1]

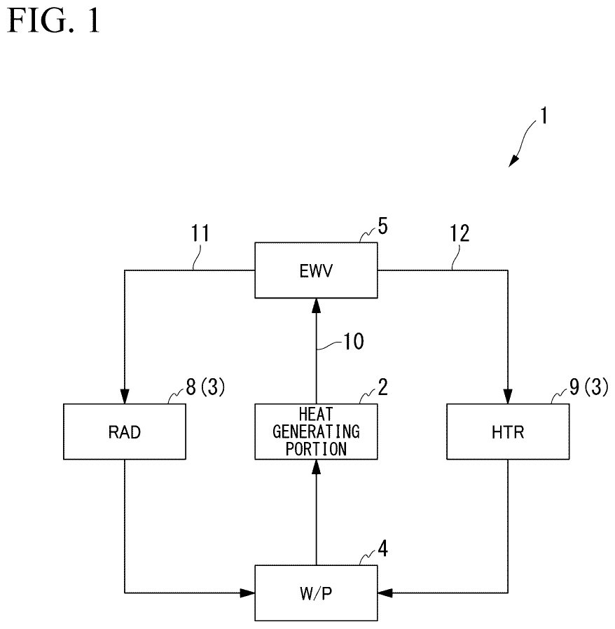

FIG. 1 is a block diagram of the cooling system 1.

As shown in FIG. 1, a cooling system 1 is mounted in, for example, a vehicle. In this embodiment, the vehicle is not limited to one having an engine (an internal combustion engine) as a vehicle drive source, and may be an electric motor vehicle. The electric motor vehicle includes an electric vehicle, a hybrid vehicle, a plug-in hybrid vehicle, a fuel cell vehicle, and the like.

The cooling system 1 includes a heat generating portion 2, a heat radiating part 3, a water pump 4 (W/P), and a control valve 5 (EWV). In the cooling system 1, the water pump 4 and the control valve 5 operate to circulate a cooling liquid between the heat generating portion 2 and the heat radiating part 3.

The heat generating portion 2 is a component to be cooled by the cooling liquid (a target for heat absorption by the cooling liquid), and is a drive source of a vehicle or other heat generating components. In the case of an electric motor vehicle, the heat generating portion 2 includes, for example, a drive motor, a battery, a power converter, and the like.

The heat radiating part 3 is a component to which heat is radiated from the cooling liquid. In this embodiment, the heat radiating part 3 includes a radiator 8 (RAD) and a heater core 9 (HTR). As the heat radiating part 3, any member can be selected as long as a temperature during a normal operation is lower than a temperature of the cooling liquid after the cooling liquid passes through the heat generating portion 2. As such a component, the heat radiating part 3 may be, for example, an EGR cooler that exchanges heat between EGR gas and the cooling liquid, a heat exchanger that exchanges heat between lubricating oil and the cooling liquid, or the like.

The water pump 4, the heat generating portion 2, and the control valve 5 are connected in order from upstream to downstream on a main flow path 10. In the main flow path 10, the cooling liquid passes through the heat generating portion 2 and the control valve 5 in order by an operation of the water pump 4.

A radiator flow path 11 and an air conditioning flow path 12 are connected to the main flow path 10.

The radiator 8 is provided in the radiator flow path 11. The radiator flow path 11 is connected to the control valve 5 at a portion located upstream of the radiator 8. The radiator flow path 11 is connected to the heat generating portion 2 at a portion located downstream of the radiator 8. In the radiator flow path 11, heat exchange between the cooling liquid and external air is performed in the radiator 8.

The heater core 9 is provided in the air conditioning flow path 12. The air conditioning flow path 12 is connected to the control valve 5 at a portion located upstream of the heater core 9. The air conditioning flow path 12 is connected to the heat generating portion 2 at a portion located downstream of the heater core 9. The heater core 9 is provided, for example, in a duct (not shown) of an air conditioner. In the air conditioning flow path 12, heat exchange is performed in the heater core 9 between the cooling liquid and conditioned air flowing through the duct.

In the cooling system 1, the cooling liquid introduced into the control valve 5 by the operation of the water pump 4 is selectively supplied to one of the heat radiating parts 3 by an operation of the control valve 5. The cooling liquid supplied to the heat radiating part 3 exchanges heat with the heat radiating part 3 during a process in which the cooling liquid passes through the heat radiating part 3. As a result, the cooling liquid is cooled by the heat radiating part 3. The cooling liquid that has passed through the heat radiating part 3 is supplied to the heat generating portion 2 and then exchanges heat with the heat generating portion 2 during a process in which the cooling liquid passes through the heat generating portion 2. Thus, the heat generating portion 2 is cooled by the cooling liquid. As described above, in the cooling system 1, during a process in which the cooling liquid is circulated between the heat generating portion 2 and the heat radiating part 3, the heat generating portion 2 is cooled by the cooling liquid, while the cooling liquid is cooled by the heat radiating part 3. Thus, in the cooling system 1, the heat generating portion 2 can be controlled to a desired temperature.

### [Control Valve 5 of First Embodiment]

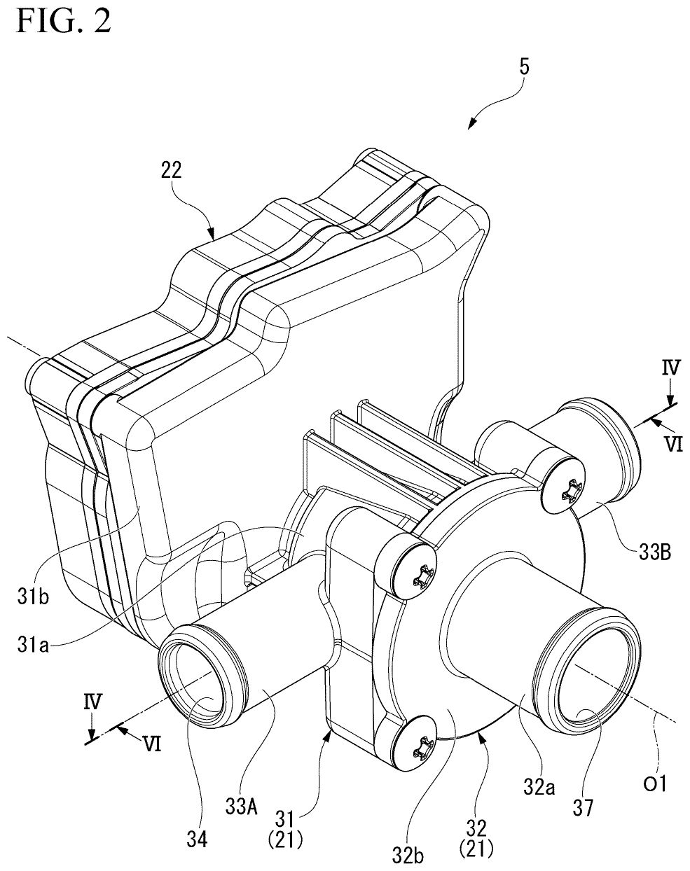

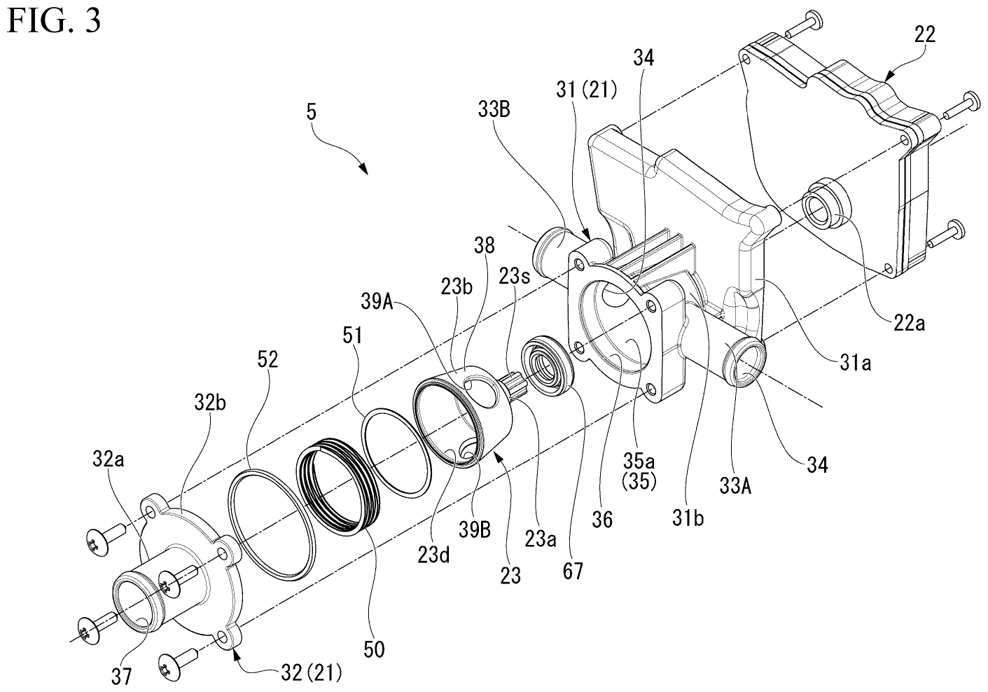

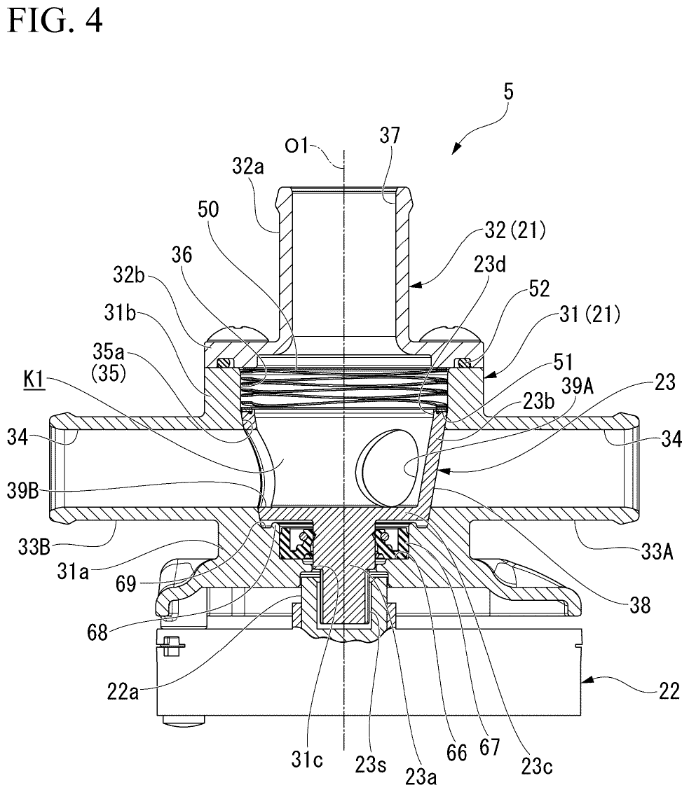

FIG. 2 is a perspective view of the control valve 5, and FIG. 3 is an exploded perspective view of the control valve 5. FIG. 4 is a cross-sectional view of the control valve 5 taken along line IV-IV in FIG. 2.

As shown in FIGS. 2 to 4, the control valve 5 includes a casing 21, a drive unit 22, and a rotor 23.

### <Casing 21>

The casing 21 includes a casing main body 31 and an introduction joint 32. The casing main body 31 is formed into a tubular shape with a bottom having a bottom wall portion 31a and a peripheral wall portion 31b. In the following description, a direction along an axis O1 of the casing main body 31 is simply referred to as an axial direction. When seen in the axial direction, a direction intersecting the axis O1 is referred to as a radial direction, and a direction around the axis O1 is referred to as a circumferential direction.

Further, in the axial direction, the side (the opening side) of the casing main body 31 opposite to the bottom wall portion 31a is referred to as one end side, and the bottom wall portion 31a side thereof is referred to as the other end side.

The bottom wall portion 31a of the casing main body 31 protrudes outward in the radial direction in a rectangular shape so that the other end side in the axial direction substantially matches an exterior of the drive unit 22 which will be described below. The drive unit 22 is superimposed on this portion, and the drive unit 22 is fixed with screws or the like. Furthermore, a through hole 31c that passes through the bottom wall portion 31a in the axial direction is formed in a portion of the bottom wall portion 31a located on the axis O1. A shaft portion 23a of the rotor 23 which will be described below is rotatably inserted into the through hole 31c.

Two outflow ports 33A and 33B that protrude outward in the radial direction are formed in the peripheral wall portion 31b of the casing main body 31. The two outflow ports 33A and 33B extend in opposite directions around the axis O1. An outlet 34 that communicates with the inside of the casing main body 31 is formed in each of the outflow ports 33A and 33B. One outflow port 33A is connected to the upstream side of one of the radiator flow path 11 and the air conditioning flow path 12 shown in FIG. 1, and the other outflow port 33B is connected to the upstream side of the other of the radiator flow path 11 and the air conditioning flow path 12.

In this embodiment, the two outflow ports 33A and 33B are provided in the peripheral wall portion 31b of the casing main body 31, but the number of outflow ports may be one or three or more according to a flow path configuration of the cooling system 1. In the case of three or more outflow ports, it is desirable that the outflow ports are disposed evenly (at equal intervals) on the circumference of the peripheral wall portion 31b.

As shown in FIG. 4, in the casing main body 31, an inner peripheral portion of the peripheral wall portion 31b closer to the bottom wall portion 31a serves as a rotor accommodating portion 35. A peripheral wall 23b of the rotor 23 which will be described below is rotatably accommodated in the rotor accommodating portion 35.

The inner peripheral surface 35a of the rotor accommodating portion 35 is formed in a tapered shape of which an inner diameter gradually decreases at a constant rate from one end side to the other end side in the axial direction. In other words, in this tapered shape, an amount of protrusion inward in the radial direction gradually increases from one end side to the other end side in the axial direction. Each of the outlets 34 of the two outflow ports 33A and 33B described above opens to the inner peripheral surface 35a of the rotor accommodating portion 35. Further, the peripheral wall 23b of the rotor 23 which will be described below is rotatably supported on the tapered inner peripheral surface 35a of the rotor accommodating portion 35. In this embodiment, the inner peripheral surface 35a of the rotor accommodating portion 35 constitutes a rotor guide surface.

In addition, a region in an inner peripheral portion of the peripheral wall portion 31b that is closer to the one end side in the axial direction than the rotor accommodating portion 35 is formed to have the same inner diameter as a maximum inner diameter of the rotor accommodating portion 35 (the inner peripheral surface 35a). This portion serves as a spring accommodating portion 36 in which a coil spring 50 which will be described below is accommodated. Further, one end side of the spring accommodating portion 36 in the axial direction opens outward of the casing main body 31, and a cooling liquid (a fluid) introduced from the introduction joint 32 which will be described below flows therethrough.

The introduction joint 32 is mounted on an end surface of the casing main body 31 on one end side in the axial direction. The introduction joint 32 includes a joint tubular portion 32a and a flange portion 32b.

An inlet 37 through which the cooling liquid (the fluid) is introduced into the casing 21 is formed in the joint tubular portion 32a. The inlet 37 is connected to the downstream side of the heat generating portion 2 of the main flow path 10 shown in FIG. 1. The flange portion 32b is formed to protrude outward in the radial direction at an end portion of the joint tubular portion 32a in the axial direction. The flange portion 32b is superimposed on the end surface of the casing main body 31 and is fixed to the end portion of the casing main body 31 by screws or the like with a packing 52 sandwiched therebetween. An inner diameter of the flange portion 32b is set smaller than an inner diameter of the spring accommodating portion 36 of the casing main body 31.

Therefore, an inner peripheral edge portion of the flange portion 32b faces inside the end portion of the spring accommodating portion 36 of the casing main body 31.

The introduction joint 32 (the flange portion 32b) may be mounted on an opening end surface of the inlet 37 by welding (for example, vibration welding, or the like).

### <Drive Unit 22>

The drive unit 22 has a built-in motor, deceleration mechanism, control board, and the like (not shown). An output shaft 22a protrudes from a surface of the drive unit 22 on the side that is mounted on the casing 21. The output shaft 22a is engaged with the shaft portion 23a of the rotor 23 that passes through the bottom wall portion 31a of the casing main body 31 to be able to transmit rotation. The shaft portion 23a of the rotor 23 can be relatively displaced in the axial direction through spline engagement with the output shaft 22a.

### <Rotor 23>

The rotor 23 is rotatably accommodated inside the casing 21. The rotor 23 accommodated in the casing 21 is rotatable around the axis O1. The rotor 23 includes the shaft portion 23a, the peripheral wall 23b, and a bottom wall 23c.

The shaft portion 23a is inserted into the through hole 31c of the bottom wall portion 31a of the casing main body 31, and the peripheral wall 23b is accommodated in the rotor accommodating portion 35 of the casing main body 31. The bottom wall 23c closes off the other end side of the peripheral wall 23b in the axial direction. The shaft portion 23a protrudes coaxially with the peripheral wall 23b at a center of the other end side of the bottom wall 23c in the axial direction. An opening portion 23d is provided at one end side of the peripheral wall 23b in the axial direction.

The rotor 23 accommodated in the casing 21 is disposed coaxially with the axis O1 of the casing 21. Therefore, a rotational axis of the rotor 23 coincides with the axis O1 of the casing 21. The shaft portion 23a passes through the bottom wall portion 31a through the through hole 31c. An outer spline 23s that is spline-engaged with the output shaft 22a of the drive unit 22 is formed on the other end side of the shaft portion 23a in the axial direction. The shaft portion 23a is spline-engaged with the output shaft 22a of the drive unit 22 outside the bottom wall portion 31a.

The peripheral wall 23b of the rotor 23 has a tapered shape (a truncated conical shape) of which an outer diameter gradually decreases at a constant rate from one end side to the other end side in the axial direction. In this embodiment, an outer peripheral surface of the peripheral wall 23b constitutes a gradually decreasing diameter surface 38. The gradually decreasing diameter surface 38 is slidably in contact with the tapered inner peripheral surface 35a of the rotor accommodating portion 35 in a state in which the peripheral wall 23b is accommodated in the rotor accommodating portion 35 of the casing main body 31. The rotor 23 is rotatably supported by the inner peripheral surface 35a of the rotor accommodating portion 35.

In this embodiment, a diameter reduction ratio of the outer diameter of the gradually decreasing diameter surface 38 (a diameter reduction ratio from one end side to the other end side in the axial direction) is set to be the same as a diameter reduction ratio of the inner peripheral surface 35a on the casing 21 side. Therefore, when the peripheral wall 23b of the rotor 23 expands and contracts due to heat, the peripheral wall 23b is smoothly guided by the inner peripheral surface 35a according to a change in the outer diameter of the peripheral wall 23b (the gradually decreasing diameter surface 38) and is displaced in the axial direction.

The gradually decreasing diameter surface 38 and the inner peripheral surface 35a on the casing 21 side do not necessarily have to be formed in a tapered shape, and may have a shape which gently curves and of which a diameter gradually decreases from one end side to the other end side in the axial direction.

Furthermore, two communication ports 39A and 39B which pass through the peripheral wall 23b in the radial direction are formed in the peripheral wall 23b of the rotor 23. In a state in which the rotor 23 is accommodated in the rotor accommodating portion 35 of the casing 21, the two communication ports 39A and 39B are formed at positions that are approximately at the same height (approximately the same axial region) as the two outlets 34 facing the inner peripheral surface 35a of the rotor accommodating portion 35. Each of the communication ports 39A and 39B communicates with one of the outlets 34 when the rotor 23 is at a predetermined rotational position.

The communication ports 39A and 39B on the rotor 23 side and the outlets 34 on the casing 21 side are set in positions, sizes, and shapes such that they can communicate reliably at a predetermined rotational position even when the peripheral wall 23b of the rotor 23 is displaced in the axial direction by expansion and contraction due to heat.

In this embodiment, the two communication ports 39A and 39B are formed in the peripheral wall 23b of the rotor 23, but the number of communication ports formed in the peripheral wall 23b may be one or three or more.

Further, the peripheral wall 23b of the rotor 23 of this embodiment is formed to have a constant thickness throughout an entire region in the circumferential direction and the axial direction. Therefore, when the rotor 23 is molded, a dividing plane of a mold can be disposed at an end portion of the peripheral wall on the other end side in the axial direction. In this case, the dividing plane is a plane perpendicular to the axial direction, and two molds with the dividing planes butted against each other can be cut out in the axial direction. In the rotor 23 formed by such a mold, no parting line is formed on the outer peripheral surface of the peripheral wall 23b. Therefore, it is possible to prevent the parting line formed on the outer peripheral surface of the rotor 23 from causing leakage of the cooling liquid at a contact surface between the outer peripheral surface of the rotor 23 and the inner peripheral surface 35a on the casing 21 side.

The opening portion 23d of the peripheral wall 23b on one end side in the axial direction communicates with the inlet 37 of the introduction joint 32 through the spring accommodating portion 36 of the casing main body 31. Therefore, the inlet 37 of the casing 21 communicates with an inner space K1 of the rotor 23 surrounded by the peripheral wall 23b and the bottom wall 23c. The cooling liquid (the fluid) introduced into the inner space K1 of the rotor 23 from the inlet 37 flows out to the outlet 34 of the outflow ports 33A and 33B through the communication port 39A or 39B according to a rotational position of the rotor 23.

### <Seal Structure of Rotor 23>

As shown in FIG. 4, a seal accommodating portion 66 is formed in the bottom wall portion 31a of the casing 21 at a position facing an outer surface (a surface on the other end side in the axial direction) of the bottom wall 23c of the rotor 23. The seal accommodating portion 66 is a recessed portion that opens to one end side in the axial direction and communicates with the through hole 31c at the center of the bottom portion. An annular seal member 67 is fitted into the seal accommodating portion 66. The seal member 67 is an annular member mainly made of an elastic member that is U-shaped in cross-sectional view. The seal member 67 seals between an outer peripheral surface of the shaft portion 23a and an inner peripheral surface of the seal accommodating portion 66 within the seal accommodating portion 66.

An annular wall 68 and an annular recess 69 are formed in the bottom wall portion 31a at a position outward of the seal accommodating portion 66 in the radial direction. The annular wall 68 is disposed inside the annular recess 69 in the radial direction and separates the seal accommodating portion 66 and the recess 69 from each other. A protruding end of the annular wall 68 is disposed close to the outer surface of the bottom wall 23c of the rotor. The recess 69 forms a stagnation region for the cooling liquid to trap contaminants and the like contained in the cooling liquid before the cooling liquid enters the seal accommodating portion 66. A surface of an inner surface of the recess 69 that faces inward in the radial direction is constituted by an inner peripheral surface of the peripheral wall portion 31b. On the other hand, a surface of the inner surface of the recess 69 that faces outward in the radial direction is formed by an outer peripheral surface of the annular wall 68.

### <Biasing Structure of Rotor 23>

As shown in FIG. 4, the coil spring 50 made of a thin plate material is accommodated in the spring accommodating portion 36 of the casing main body 31 together with a spring receiving member 51 in the form of an annular sheet. The coil spring 50 is formed to have approximately the same outer diameter as an end surface of the peripheral wall 23b of the rotor 23 on one end side in the axial direction. The spring receiving member 51 is disposed at an end portion of the coil spring 50 on the other end side in the axial direction. An end surface of the spring receiving member 51 on the rotor 23 side is formed to be flat. When the coil spring 50 and the spring receiving member 51 are accommodated in the spring accommodating portion 36, the spring receiving member 51 comes into contact with the end surface of the peripheral wall 23b of the rotor 23. At this time, a lower end surface of the coil spring 50 comes into contact with an inner peripheral edge portion of the flange portion 32b of the introduction joint 32.

The coil spring 50 is a compression spring, and urges the rotor 23 to the other end side in the axial direction in a state in which it is accommodated in the spring accommodating portion 36. A biasing force of the coil spring 50 presses the gradually decreasing diameter surface 38 of the peripheral wall 23b of the rotor 23 against the inner peripheral surface 35a (the rotor guide surface) on the casing 21 side with a weak force.

Further, a flow of the cooling liquid introduced into the inner space K1 of the rotor 23 from the inlet 37 of the casing 21 hits the peripheral wall 23b and the bottom wall 23c of the rotor 23, thereby pressing the rotor 23 to the other end side in the axial direction. Therefore, the flow of the cooling liquid introduced into the inner space K1 of the rotor 23 presses the gradually decreasing diameter surface 38 of the peripheral wall 23b of the rotor 23 against the inner peripheral surface 35a (the rotor guide surface) on the casing 21 side with a weak force.

### <Method of Operating Control Valve 5>

Next, a method of operating the control valve 5 described above will be described. In the following description, it is assumed that the outlet 34 of one outflow port 33A of the casing 21 is connected to the radiator flow path 11, and the outlet 34 of the other outflow port 33B is connected to the air conditioning flow path 12.

As shown in FIG. 1, in the main flow path 10, the cooling liquid sent out by the water pump 4 exchanges heat in the heat generating portion 2, and then flows toward the control valve 5. The cooling liquid that has passed through the heat generating portion 2 in the main flow path 10 is introduced into the inner space K1 through the inlet 37 of the introduction joint 32 shown in FIG. 4. The cooling liquid that has been introduced into the inner space K1 fills the entire region inside the casing main body 31 through the communication ports 39A and 39B, a gap between the rotor 23 and the casing 21, and the like.

When the communication ports 39A and 39B of the rotor 23 are not superimposed on the outlet 34 of any of the outflow ports 33A and 33B when seen in the radial direction, communication between the inner space K1 of the rotor 23 and the outlets 34 of the outflow ports 33A and 33B is blocked (a blocked state). In the blocked state, the introduction of the cooling liquid in the inner space K1 into the outlet 34 through the communication ports 39A and 39B is restricted.

When it is desired to supply the cooling liquid to the radiator 8, for example, the communication port 39A and the outlet 34 of one outflow port 33A communicate with each other. Specifically, the drive unit 22 is driven to rotate the rotor 23 around the axis O1. At this time, the rotor 23 rotates around the axis O1 while the gradually decreasing diameter surface 38 of the peripheral wall 23b slides on the inner peripheral surface 35a (the rotor guide surface) of the casing main body 31. Then, the communication port 39A is superimposed on the outlet 34 of one outflow port 33A when seen in the radial direction, and thus the communication port 39A and the outlet 34 of one outflow port 33A communicate with each other (a communicating state). In the communicating state, the cooling liquid in the inner space K1 flows out to the outlet 34 through the communication port 39A. The cooling liquid flowing out to the outlet 34 is distributed to the radiator flow path 11 as shown in FIG. 1. The cooling liquid distributed to the radiator flow path 11 passes through the radiator 8, is then returned to the main flow path 10 and is introduced into the control valve 5 again.

On the other hand, when it is desired to supply the cooling liquid to the heater core 9, the communication port 39B communicates with the outlet 34 of the other outflow port 33B, for example, by a method similar to the method described above. Thus, the cooling liquid flowing out of the inner space K1 flows into the outlet 34 of the other outflow port 33B and is distributed to the air conditioning flow path 12.

In this way, in the control valve 5 of this embodiment, communication and disconnection between the inner space K1 and each of the outlets 34 through the communication ports 39A and 39B are switched according to the rotational position of the rotor 23. Thus, the cooling liquid can be distributed to a desired flow path.

### Effects of First Embodiment

As described above, in the control valve 5 of this embodiment, the gradually decreasing diameter surface 38 of which an outer diameter gradually decreases from one end side to the other end side in the axial direction is provided on the peripheral wall 23b of the rotor 23, and the inner peripheral surface 35a (the rotor guide surface) of which the amount of protrusion inward in the radial direction gradually increases from one end side to the other end side in the axial direction is provided in the rotor accommodating portion 35 on the casing 21 side. The inner peripheral surface 35a (the rotor guide surface) of the rotor accommodating portion 35 is slidably in contact with the gradually decreasing diameter surface 38 on the rotor 23 side, and the outlets 34 are formed so as to face the gradually decreasing diameter surface 38. With this configuration, when the outer diameter of the peripheral wall 23b of the rotor 23 expands or contracts due to heat, the rotor 23 is displaced in the axial direction on the inner peripheral surface 35a (the rotor guide surface) of the rotor accommodating portion 35 according to an increase or decrease in the outer diameter of the peripheral wall 23b. Therefore, the gradually decreasing diameter surface 38 of the rotor 23 is stably and slidably supported on the inner peripheral surface 35a of the rotor accommodating portion 35, regardless of the expansion and contraction changes of the peripheral wall 23b due to heat.

Furthermore, in this configuration, since the peripheral edge portion of the inner peripheral surface 35a of the rotor accommodating portion 35 at the portion at which the outlets 34 are disposed is slidably in contact with the gradually decreasing diameter surface 38 on the rotor 23 side, the seal cylinder for allowing communication between the outlets 34 and the communication ports 39A and 39B of the peripheral wall 23b of the rotor 23 and the biasing member for biasing the seal cylinder in the direction of the peripheral wall of the rotor 23 can be omitted.

Therefore, when the control valve 5 of this embodiment is adopted, the number of components such as bearings, the seal cylinder, and the biasing member can be reduced and the structure can be simplified, thereby making it possible to reduce a size of the entire device.

Further, in the control valve 5 of this embodiment, the gradually decreasing diameter surface 38 on the rotor 23 side and the inner peripheral surface 35a of the rotor accommodating portion 35 on the casing 21 side are both tapered surfaces of which inclinations change at a constant rate from one end side to the other end side in the axial direction. Therefore, even when the peripheral wall 23b of the rotor 23 expands and contracts due to heat and thus the rotor 23 is displaced in the axial direction, the gradually decreasing diameter surface 38 and the inner peripheral surface 35a of the rotor accommodating portion 35 can be brought into stable contact over a wide area.

Therefore, when this configuration is adopted, it is possible to stabilize the operation of the rotor 23, and it is also possible to prevent unnecessary internal leakage of the cooling liquid.

Further, in the control valve 5 of this embodiment, the opening portion 23d is provided at one end side of the peripheral wall 23b of the rotor 23, the other end side of the peripheral wall 23b of the rotor 23 is closed by the bottom wall 23c, the opening portion 23d communicates with the inlet 37 of the casing 21, and the outlet 34 is formed in the inner peripheral surface of the rotor accommodating portion 35 on the casing 21 side. Therefore, when the cooling liquid is introduced into the casing 21 from the inlet 37, the cooling liquid is introduced into the peripheral wall 23b through the opening portion 23d of the rotor 23. At this time, the rotor 23 is pressed to the other end side in the axial direction by pressure of the cooling liquid, and a component force thereof acts as a pressing force that presses the gradually decreasing diameter surface 38 of the rotor 23 against the inner peripheral surface 35a on the casing 21 side. As a result, when the gradually decreasing diameter surface 38 of the rotor 23 is pressed against the peripheral edge portion of the outlet 34 of the inner peripheral surface 35a on the casing 21 side, and the communication ports 39A and 39B of the rotor 23 communicate with the outlet 34, leakage of the cooling liquid from the peripheral edge portion of the outlet 34 is curbed. Furthermore, when the communication ports 39A and 39B of the rotor 23 do not communicate with the outlet 34, leakage of the cooling liquid to the outlet 34 is curbed.

Therefore, when this configuration is adopted, the gradually decreasing diameter surface 38 on the rotor 23 side is always in stable contact with the inner peripheral surface 35a on the casing 21 side, and unnecessary internal leakage of the cooling liquid can be curbed.

Further, in the control valve 5 of this embodiment, the coil spring 50 (the biasing member) that urges the rotor 23 to the other end side in the axial direction is provided between the casing 21 and the rotor 23. Therefore, the component force of the coil spring 50 that urges the rotor 23 to the other end side in the axial direction acts as a force that presses the gradually decreasing diameter surface 38 of the rotor 23 against the inner peripheral surface 35a on the casing 21 side.

Therefore, when this configuration is adopted, the gradually decreasing diameter surface 38 on the rotor 23 side is always brought into stable contact with the inner peripheral surface 35a on the casing 21 side, thereby making it possible to further curb unnecessary internal leakage of the cooling liquid.

Further, in the control valve 5 of this embodiment, the inner peripheral surface 35a of the rotor accommodating portion 35 is formed in the rotor accommodating portion 35 in an annular shape so as to surround a peripheral region of the gradually decreasing diameter surface 38 of the rotor 23. Therefore, the rotor 23 can be maintained in a stable posture during the rotation of the rotor 23.

Therefore, when this configuration is adopted, the operation of the rotor 23 can be made more stable.

Furthermore, in the control valve 5 of this embodiment, the spring receiving member 51 having a flat contact surface with the rotor 23 is mounted on the end surface of the coil spring 50 (the biasing member) on the rotor 23 side that urges the rotor 23 to the other end side in the axial direction. In this case, since, while the coil spring 50 that is highly durable and has a simple structure is adopted as the biasing member, the biasing force of the coil spring 50 acts on the rotor 23 through the spring receiving member 51, it is possible to prevent the end portion of the coil spring 50 from interfering with the rotation of the rotor 23 when the rotor 23 rotates, and it is also possible to prevent the end portion of the coil spring from damaging the end surface of the rotor 23.

Therefore, when this configuration is adopted, smooth rotation of the rotor 23 can be obtained, and damage to the rotor 23 can also be prevented.

### [Control Valve 105 of Second Embodiment]

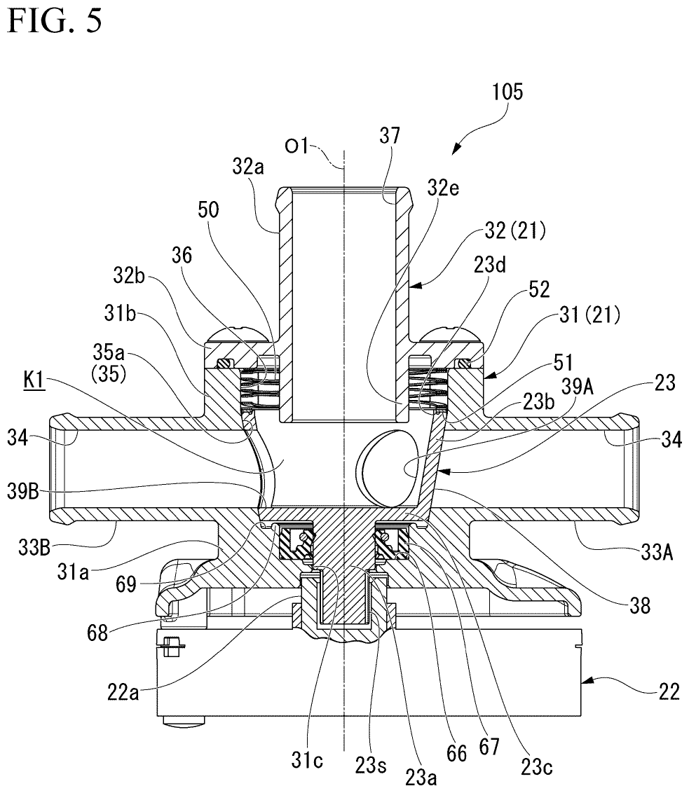

FIG. 5 is a cross-sectional view of the control valve 105 of this embodiment which corresponds to FIG. 4 of the first embodiment.

The basic configuration of the control valve 105 of this embodiment is the same as that of the above embodiment, but a structure of a part of the introduction joint 32 is different from the above embodiment. That is, a tubular wall 32e that extends into the opening portion 23d of the peripheral wall 23b of the rotor 23 in the axial direction within the casing main body 31 is provided on the introduction joint 32. The inlet 37 of the casing 21 is formed across the joint tubular portion 32a of the introduction joint 32 and the tubular wall 32e.

### Effects of Second Embodiment

Since the control valve 105 of this embodiment has the same basic configuration as the above embodiment, it can obtain the same basic effects as the above embodiment.

Further, in the control valve 105 of this embodiment, the tubular wall 32e that extends into the opening portion 23d of the peripheral wall 23b of the rotor 23 is provided on the introduction joint 32, and the inlet 37 is formed in the tubular wall 32e of the introduction joint 32. Therefore, when the cooling liquid (the fluid) is introduced into the peripheral wall 23b of the rotor 23 from the inlet 37, a flow of the fluid is less likely to directly hit the end portion of the peripheral wall 23b on the one end side in the axial direction or a peripheral portion thereof (a wall of the spring accommodating portion 36 or the coil spring 50). Therefore, when the configuration of this embodiment is adopted, pressure loss of the cooling liquid introduced into the peripheral wall 23b of the rotor 23 can be curbed.

### [Control Valve 205 of Third Embodiment]

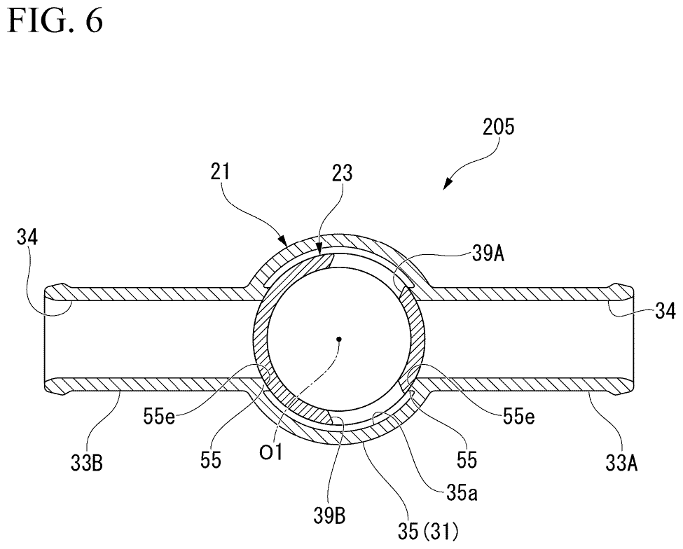

FIG. 6 is a cross-sectional view of a control valve 205 of this embodiment which corresponds to the cross section taken along line VI-VI of the first embodiment.

The rotor accommodating portion 35 of the casing 21 of the first embodiment has the inner peripheral surface 35a formed in a tapered shape such that the inner diameter gradually decreases from one end side to the other end side in the axial direction. In contrast, the inner peripheral surface 35a of the rotor accommodating portion 35 of this embodiment is formed to have a constant inner diameter or to have an inner diameter that gradually decreases from one end side to the other end side in the axial direction. A boss portion 55 is formed in a portion of the inner peripheral surface 35a of the rotor accommodating portion 35 in which the outlet 34 of each of the outflow ports 33A and 33B opens so as to surround each of the outlets 34. Each of the boss portions 55 protrudes inward toward the gradually decreasing diameter surface 38 of the rotor 23 in the radial direction.

An end surface 55e of each of the boss portions 55 on the protrusion side is slidably in contact with the gradually decreasing diameter surface 38 of the rotor 23. The end surface 55e of each of the boss portions 55 is formed to have a complementary shape to a part of the gradually decreasing diameter surface 38. Specifically, the end surface 55e of the boss portion 55 has an arc-shaped cross section perpendicular to the axis O1, and an inner diameter of the arc gradually decreases from one end side to the other end side in the axial direction. In other words, an amount of protrusion of the end surface 55e of the boss portion 55 inward in the radial direction gradually increases from one end side to the other end side in the axial direction.

In this embodiment, the end surfaces 55e of the plurality of boss portions 55 constitute a rotor guide surface on the casing 21 side.

Further, in this embodiment, although a boss portion 55 is formed at a portion of the inner peripheral surface 35a of the rotor accommodating portion 35 in which the outlets 34 of the two outflow ports 33A and 33B open, when there are three or more outflow ports, the number of boss portions 55 may be increased in accordance with the number of outflow ports (outlets). In this case, it is desirable that the boss portions 55 be disposed evenly in the circumferential direction of the inner peripheral surface 35a. Furthermore, the number of boss portions 55 may be greater than the number of outflow ports (outlets). In this case, some of the boss portions 55 are not formed with the outflow ports. For example, when there is one outflow port (outlet), one or more boss portions 55 without the outflow port are provided, and all the boss portions are disposed evenly in the circumferential direction of the inner peripheral surface 35a. Thus, the support of the rotor 23 by the end surface 55e (the rotor guide surface) of the boss portion 55 can be maintained in a good balance.

### Effects of the Third Embodiment

Since the control valve 205 of this embodiment has a basic configuration that is almost the same as that of the first embodiment, it can obtain the same basic effects as the first embodiment.

Further, in the control valve 205 of this embodiment, only the end surface 55e of each of the boss portions 55 formed on the inner peripheral surface 35a of the rotor accommodating portion 35 comes into contact with the gradually decreasing diameter surface 38 on the rotor 23 side as the rotor guide surface. Therefore, a contact area between the gradually decreasing diameter surface 38 and the rotor guide surface is smaller than that in the first and second embodiments.

Therefore, when the control valve 205 of this embodiment is employed, sliding resistance during the rotation of the rotor 23 can be reduced, and the rotation of the rotor 23 can be made smoother.

In the first, second, and third embodiments described above, although the configuration in which the inlet 37 faces in the axial direction, and the outlet 34 faces in the radial direction has been described, the present invention is not limited to this configuration. For example, a configuration in which the outlet faces in the axial direction and the inlet faces in the radial direction, or a configuration in which both the inlet and the outlet face in the radial direction may be used. In this case, the outlet may communicate with the inner space within the rotor, and the inlet may be opened and closed by a communication port in the peripheral wall (the gradually decreasing diameter surface) of the rotor.

### [Control Valve 305 of Fourth Embodiment]

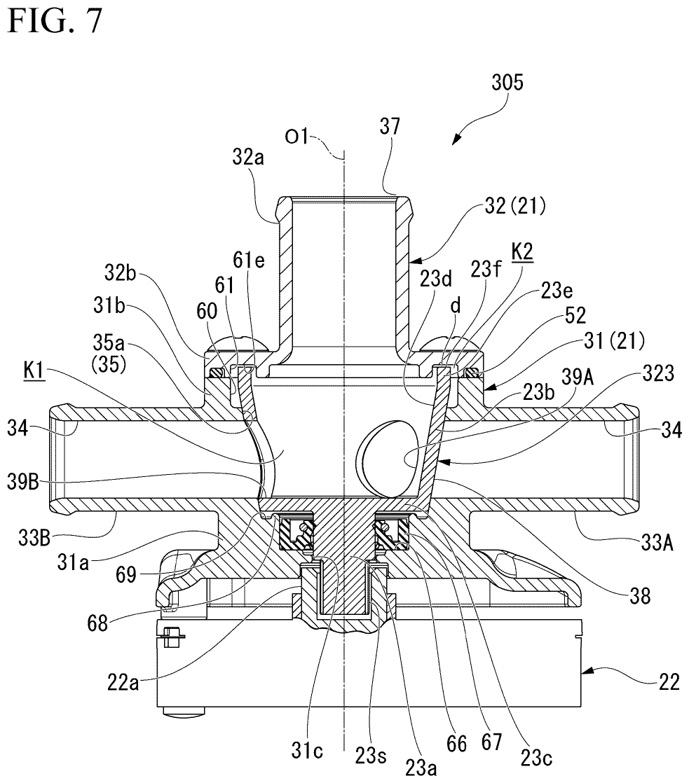

FIG. 7 is a cross-sectional view of a control valve 305 of this embodiment which corresponds to FIG. 4 of the first embodiment.

The control valve 305 of this embodiment is not provided with the biasing member such as a coil spring for biasing a rotor 323 to the other end side in the axial direction. The rotor 323 includes the shaft portion 23a, the peripheral wall 23b, and the bottom wall 23c, as in the above embodiment. However, the outer peripheral surface of the peripheral wall 23b does not have a tapered shape over the entire region in the axial direction, but a straight portion 23e having a constant outer diameter is provided at one end side in the axial direction.

Further, an annular recess 60 which opens to the inner side in the radial direction and the one end side in the axial direction is formed in the casing main body 31 at a position adjacent to one end side of the rotor accommodating portion 35 in the axial direction. Further, an annular groove 61 that opens to the other end side in the axial direction is formed in the end surface of the flange portion 32b of the introduction joint 32 that faces the inside of the casing 21. A peripheral surface of the recess 60 of the casing main body 31 that faces inward in the radial direction is continuous with an outer peripheral surface of the annular groove 61 of the introduction joint 32. The recess 60 and the annular groove 61 form an annular end receiving space K2 in which a part of the inner peripheral wall and the bottom wall (the wall located on the other end side in the axial direction) is missing. The straight portion 23e at the end portion of the peripheral wall 23b of the rotor 23 is accommodated in the end receiving space K2 so as to be movable back and forth in the axial direction. A gap d is secured between an end portion 23f of the straight portion 23e accommodated in the end receiving space K2 and a bottom surface 61e of the annular groove 61. This gap d is a gap for allowing the displacement of the peripheral wall 23b (the straight portion 23e) to one end side in the axial direction when the rotor 323 is displaced to one end side in the axial direction due to thermal expansion of the peripheral wall 23b of the rotor 323.

Although the control valve 305 of this embodiment does not include a biasing member for biasing the rotor 323 to the other end side in the axial direction, the flow of cooling liquid (the fluid) introduced from the inlet 37 presses the rotor 323 to the other end side in the axial direction. As a result, the gradually decreasing diameter surface 38 of the rotor 323 is pressed against the tapered inner peripheral surface 35a on the casing 21 side. Therefore, even when the rotor 323 expands and contracts due to heat, it is slidably and stably supported by the inner peripheral surface 35a on the casing 21 side.

### Effects of the Fourth Embodiment

Since the control valve 305 of this embodiment has a basic configuration that is almost the same as that of the first embodiment, it can obtain the same basic effects as the first embodiment.

However, since the control valve 305 of this embodiment is not provided with an biasing member for biasing the rotor 323 to the other end side in the axial direction, the number of parts can be further reduced, and an axial length of the control valve 305 can be shortened.

Further, in the control valve 305 of this embodiment, the bottom surface 61e of the annular groove 61 faces the end portion 23f of the peripheral wall 23b (the straight portion 23e) of the rotor 323 with a small gap d therebetween. Therefore, the bottom surface 61e of the annular groove 61 can curb excessive displacement of the rotor 323 in the axial direction and unnecessary rattling in a state in which the rotor 323 is not operated.

### OTHER EMBODIMENTS

Although preferred embodiments of the present invention have been described above, the present invention is not limited to the embodiments. Additions, omissions, substitutions, and other changes to the configuration are possible without departing from the gist of the present invention. The present invention is not limited by the above description, but is limited only by the scope of the claims appended hereto.

For example, in the embodiment described above, the configuration in which the control valve 5 is mounted in the cooling system 1 of the vehicle has been described, but the control valve 5 is not limited to this configuration and may be mounted in other systems.

In the embodiment described above, the configuration in which the cooling liquid introduced into the control valve 5 is distributed to the radiator flow path 11 and the air conditioning flow path 12 has been described, but the present invention is not limited to this configuration. The control valve 5 may have any structure as long as it distributes the cooling liquid introduced into the control valve 5 into a plurality of flow paths.

In the first and second embodiments described above, the coil spring 50 made of a plate-shaped material is used as the biasing member that urges the rotor 23 to the other end side in the axial direction, but the present invention is not limited to this configuration. As the biasing member, various other members such as a disc spring or a rubber-like elastic member can be used.

### REFERENCE SIGNS LIST

5, 105, 205, 305 Control valve
21 Casing
23 Rotor
23b Peripheral wall
23c Bottom wall
23d Opening portion
32e Tubular wall
34 Outlet
35 Rotor accommodating portion
35a Inner peripheral surface (rotor guide surface)
37 Inlet
38 Gradually decreasing diameter surface
39A, 39B Communication port
50 Coil spring (biasing member)
51 Spring receiving member
55 Boss portion
55e End surface (rotor guide surface)

1. A control valve comprising:
a casing having an inlet through which a fluid is introduced from an outside and an outlet through which the fluid flows out to the outside; and
a rotor having a peripheral wall in which a communication port passing therethrough in a radial direction is formed, rotatably accommodated inside the casing, and configured to switch between a communication state in which the inlet and the outlet communicate with each other through the communication port and a blocking state in which communication between the inlet and the outlet is blocked in a region of the peripheral wall in which the communication port is not provided, according to a rotational position,
wherein the peripheral wall of the rotor has a gradually decreasing diameter surface of which an outer diameter gradually decreases from one end side to the other end side in an axial direction along a rotational axis of the rotor and in which the communication port is formed,
a rotor accommodating portion of the casing that accommodates the rotor has a rotor guide surface in which an amount of protrusion inward in the radial direction gradually increases from the one end side to the other end side in the axial direction and an inner end surface in the radial direction is slidably in contact with the gradually decreasing diameter surface of the peripheral wall, and
the outlet is disposed in a part of the rotor guide surface to face the gradually decreasing diameter surface of the rotor.

2. The control valve according to claim 1, wherein the gradually decreasing diameter surface is formed by a tapered surface of which an outer diameter gradually decreases at a constant rate from the one end side to the other end side in the axial direction, and
the rotor guide surface is formed by a tapered surface of which an amount of protrusion inward in the radial direction gradually increases from the one end side to the other end side in the axial direction at the same constant rate as the gradually decreasing diameter surface.

3. The control valve according to claim 1, wherein, in the rotor, an opening portion is provided on the one end side of the peripheral wall in the axial direction, and the other end side in the axial direction is closed by a bottom wall, and
the opening portion communicates with the inlet.

4. The control valve according to claim 3, wherein the inlet is formed in a tubular wall that extends into the opening portion in the axial direction of the peripheral wall.

5. The control valve according to claim 1, wherein a biasing member that urges the rotor to the other end side in the axial direction is disposed between the casing and the rotor.

6. The control valve according to claim 1, wherein the rotor guide surface is formed in an annular shape in the rotor accommodating portion to surround a peripheral region of the gradually decreasing diameter surface.

7. The control valve according to claim 1, wherein a plurality of boss portions that protrude toward the gradually decreasing diameter surface of the rotor are provided on an inner peripheral surface of the rotor accommodating portion, and
an end surface of each of the boss portions serves as the rotor guide surface, and the outlet is disposed in an end surface of at least one of the boss portions.

8. The control valve according to claim 7, wherein the plurality of boss portions are provided on the inner peripheral surface of the rotor accommodating portion at equal intervals in a circumferential direction.

9. The control valve according to claim 5, wherein the biasing member is a coil spring, and a spring receiving member having a flat contact surface with the rotor is disposed at an end portion of the coil spring on the rotor side.
